(19) United States
(12) Patent Application Publication
(10) Pub. No.: US 2025/0011962 A1
(43) Pub. Date: Jan. 9, 2025

(54) METHOD FOR SURFACE CONTRAST LASER MARKING OF ANODIZED ALUMINUM OR ALUMINUM ALLOY PARTS

(71) Applicant: SAFRAN AEROSYSTEMS, PLAISIR (FR)

(72) Inventors: Patrick EPALLE, MOISSY-CRAMAYEL (FR); Jean-Arthur DREVET, MOISSY-CRAMAYEL (FR); Nordine MAKHLOUF, MOISSY-CRAMAYEL (FR); Cynthia MOIROUD, MOISSY-CRAMAYEL (FR)

(73) Assignee: SAFRAN AEROSYSTEMS, PLAISIR (FR)

(21) Appl. No.: 18/712,358

(22) PCT Filed: Nov. 23, 2022
(86) PCT No.: PCT/FR2022/052161

§ 371 Date: May 22, 2024

(30) Foreign Application Priority Data
Nov. 29, 2021 (FR) FR2112629

(51) Int. Cl. C25D 11/08; B23K 26/362; B23K 26/40; B23K 103/10; C25D 11/24

(52) U.S. Cl. CPC C25D 11/08; B23K 26/362; B23K 26/40; C25D 11/243; C25D 11/246; B23K 2103/10

(57) ABSTRACT

A method for marking the surface of an aluminum or aluminum alloy part includes an anodizing step, a sealing step, and a marking step that uses a fiber laser beam. The marking method may be used for the manufacture or marking of aluminum or aluminum alloy parts intended for the aeronautical, aerospace, automotive, railway, watchmaking, medical, nuclear and oil industries.

### TECHNICAL FIELD OF THE INVENTION

The field of the invention concerns the contrast laser marking or engraving of aluminum or aluminum alloy parts to improve the resistance of these parts to biocorrosion and salt spray environments.

The contrast laser marking can also be used to create a contrast marking on the surface of an aluminum or aluminum alloy part, without removing any material. This facilitates and guarantees the visibility and reliable, repeatable reading of a Data Matrix Code (DMC) or Unique Device Identification (UDI) code, for example, regardless of the environment in which it is read (dark or light) and the angle at which it is read.

The contrast laser-marked aluminum or aluminum alloy parts are used in the aeronautical, aerospace, automotive, rail, watchmaking, medical, nuclear and oil industries, among others.

### TECHNICAL BACKGROUND

The marking metal parts with text, logos, images, numbers, 2D codes, etc. for traceability, anti-counterfeiting and/or part identification is used in many sectors such as aeronautics, aerospace, automotive, rail, watchmaking, medical, nuclear, oil, etc. For the purposes of this presentation, the terms “marking” and “engraving” may be used interchangeably to refer to the same operation or method. The laser marking is a method that has attracted growing interest over the last few decades because it offers a number of advantages: it is fast, it allows high-precision marking for consistent quality, and it is resistant to wear and heat. However, the laser marking is a subtractive method based on the use of a laser beam that removes material with each laser pulse. The metal parts, in particular those made of aluminum or aluminum alloy, marked in this way are exposed (e.g. white colour-raw aluminum) and are not resistant to corrosion and biocorrosion. Currently, the anti-corrosion treatment after marking consists of chemical conversion by applying a protective coating, for example, with Bonderite MCR 1200 from the company Henkel, or with Surtec 650 from the company Surtec. This means more stages in the manufacture of the part or equipment, a longer manufacturing cycle time, and an increase in the risk of non-quality, as the more stages there are in a manufacturing cycle, the greater the risk of poor workmanship, etc.

In the case of engraving/marking with a white tint, the parts cannot resist biocorrosion even with post-treatment (conversion, for example).

US 2003/0201259 describes a method for marking the surface of an aluminum or aluminum alloy part having an anodized layer on the surface, the method comprising a step of marking a region of the surface with a laser beam having a wavelength of between 700 and 1400 nm, in particular between 1000 and 1100 nm, and more particularly 1064 nm. The laser beam penetrates at least most of the anodized surface layer and locally induces a visual change that can be observed with the naked eye. The zones of the unmarked anodized layer located further out remain unchanged. The protective effect of the anodized layer is not damaged, and the layer remains free of irregularities on the outside as it was before the application of the marking.

Another disadvantage of laser marking on the metal parts, in particular aluminum or aluminum alloys, is its visibility and legibility. At present, the markings have low contrast and are therefore not very visible/readable or are only readable in certain environments and under certain conditions. The post-marking treatment by chemical conversion can also alter the visibility/legibility of the marking.

There is therefore a real need for a laser-based method for marking the surface of an aluminum or aluminum alloy part to improve the biocorrosion and corrosion resistance properties of aluminum or aluminum alloy parts, without the need for post-marking chemical conversion treatment, and which complies with the REACH regulation.

In particular, there is a real need for a method for marking the surface of an aluminum or aluminum alloy part using the laser:
which enables a contrasting marking where the contrast between the laser markings and the processed substrate is substantially increased to facilitate the visibility, legibility and readability of said marking in any environment; and/or
which enables high-precision marking for consistent quality that is resistant to wear and tear and corrosive environments; and/or
which is suitable for small, fine markings on small surfaces, such as DMC (Data Matrix Code) and UDI (Unique Device Identification) codes; and/or
which enables the marked part to withstand corrosive environments, salt spray and bio-corrosion without the need for an additional post-marking chemical conversion treatment step.

### SUMMARY OF THE INVENTION

The purpose of the present invention is precisely to meet these needs, in particular in terms of corrosion and biocorrosion resistance of the treated part and visibility/legibility of the marking, by providing a method for surface marking of an aluminum or aluminum alloy part, comprising at least the following steps:
A) an anodizing step;
B) a step of sealing the anodic layer formed on said part at the end of step A), with the sealing being carried out
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C., or
in the deionized water with a resistivity equal to or greater than 0.01 MOhms, preferably equal to or greater than 0.1 MOhms, more preferably equal to or greater than 10 MOhms, at a temperature of between 60° C. and 100° C.;
D) a marking step using a fiber laser beam having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

The step B is compulsory, as without sealing the corrosion and biocorrosion resistance is no longer compliant. However, there are two options behind step B: sealing with silicate salt or with boiling water alone (without silicate salt). The first will enable the subsequent engraving (which is the subject of the patent application) to guarantee corrosion and biocorrosion resistance, while the second will only guarantee corrosion resistance of the engraving thus produced.

In a preferred embodiment, the fiber laser is a Master Oscillator Power Amplifier (MOPA) laser. The surface marking of an aluminum or aluminum alloy part according to the method of the invention is well contrasted, i.e. the contrast between the laser markings and the surface of the treated part is substantially increased, thus facilitating the visibility and reading of said marking whatever the environment and whatever the luminosity. Furthermore, the aluminum or aluminum alloy part provided with a marking produced by the method of the invention has good resistance to biocorrosion, to corrosion, in particular to salt spray and to corrosive or acidic environments, without any post-marking chemical treatment.

Another object of the invention concerns the use of a marking method according to the invention for the manufacture or marking of aluminum or aluminum alloy parts intended for the aeronautical, aerospace, automotive, railway, watchmaking, medical, nuclear and oil industries, etc.

### BRIEF DESCRIPTION OF THE FIGURES

Further characteristics and advantages of the invention will become apparent from the following detailed description, for the understanding of which reference is made to the appended drawing in which:

FIG. 1 shows a diagram of the set-up for carrying out the biocorrosion test on specimens treated by the method of the invention in accordance with section 4.7.19 of standard MIL-C-27725B.

### DETAILED DESCRIPTION OF THE INVENTION

The purpose of the present invention is precisely to meet these needs, in particular in terms of corrosion and biocorrosion resistance of the treated part and visibility/legibility of the marking, by providing a method for surface marking of an aluminum or aluminum alloy part, comprising at least the following steps:
A) an anodizing step;
B) a step of sealing the anodic layer formed on said part at the end of step A),
with the sealing being carried out
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C.,
or
in the deionized water having a resistivity equal to or greater than 0.01 MOhms, preferably equal to or greater than 0.1 MOhms, more preferably equal to or greater than 10 MOhms, at a temperature of between 60° C. and 100° C.;
D) a marking step using a fiber laser beam having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

The method according to the invention enables contrasting marking on the aluminum or aluminum alloy parts such that the part provided with its marking is resistant to corrosion, in particular in salt spray environments and to biocorrosion.

The anodizing step A) is carried out under the conditions described in the application FR 3106837.

The sealing step B), when it takes place in an aqueous solution of deionized water and an alkali metal or alkaline earth metal silicate, as defined above, is carried out under the conditions described in the application FR 3106837.

According to a preferred embodiment of the invention, the anodizing step A) is an anodizing step during which said part is immersed in an aqueous bath comprising sulfuric acid at a concentration of between 150 and 250 g/L, to a temperature of between 14 and 21° C., and a direct voltage is applied to said immersed part according to a voltage profile comprising a voltage rise at a speed of less than 1 V/min until a voltage value referred to as plateau value of between 5 and 13 V is reached.

Once the voltage value referred to as plateau value is reached, the applied voltage is maintained at said plateau value for an adequate period of time in order to obtain an anodic layer on the surface of said part with a thickness of between 2 and 7 μm.

The voltage applied to said immersed part can be maintained at the plateau value for a period of time between 20 and 80 minutes.

The voltage value referred to as plateau value can be between 6 and 10V.

This anodizing is a fine OAS (fine sulfuric acid anodizing).

In the method of the invention, the anodizing step A) can also be an anodizing step of the TSA, OAS, PSAA, BSAA or OAC type. These anodizations are well known to those skilled in the art and are also described in: https://www.a3ts.org/actualite/commissions-techniques/fiches-techniques-traitement-surface/anodisation-sulfo-tartrique-oast-tartric-sulfuric-anodizing-tsa/for TSA (Tartric Sulfuric Acid Anodizing), https://www.a3ts.org/actualite/commissions-techniques/fiches-techniques-traitement-surface/anodisation-sulfurique-version-5-2/ for OAS (Oxydation Anodique Sulfurique), https://www.anoplate.com/finishes/boric-sulfuric-acid-anodize-bsaa/for BSAA Acid (Boric sulfuric Anodizing), http://www.metroplating.co.uk/phosphoric-acid-anodizing.php for PSAA (Phosporic sulfuric Acid Anodizing), etc.

Preferably, the anodizing in step A) is a fine OAS.

The method of the invention is particularly suitable for aluminum and aluminum alloy parts selected from the group consisting of 2014, 2017A, 2024, 2214, 2219, 2618, AU5NKZr, 7175, 5052, 5086, 6061, 6063, 7010, 7020, 7050, 7050 T7451, 7055 T77, 7068, 7085 T7651, 7075, 7175 and 7475, AS7G06, AS7G03, AS10G, AS9U3, AS7G06 and AS10G being obtained by a different production method, namely additive manufacturing.

As indicated, the voltage profile applied to the part comprises a voltage rise, from a starting value of 0V, at a speed lower than 1V/min, preferably 0.3V/min to 0.7V/min, until reaching a voltage value referred to as plateau value of between 5 and 13V, preferably between 6 and 10V. The voltage applied to said part immersed in said bath is then maintained at said plateau value for a suitable period of time to obtain an anodic layer of aluminum oxides/hydroxides on the surface of said part, with a thickness of between 2 and 7 μm, for example, with a thickness equal to approximately 5 μm.

According to an embodiment of the invention, the voltage applied to said immersed part is maintained at the plateau value for a period of time between 20 and 80 minutes, preferably between 30 and 60 minutes.

In the anodizing step A) according to the preferred embodiment of the invention, the sulfuric acid concentration in the bath is preferably between 160 g/L and 220 g/L, for example equal to 190 g/L.

In the anodizing step A) according to the preferred embodiment of the invention, the bath temperature can be between 1° and 25° C., preferably between 14 and 21° C., for example 18° C. The anodizing step A) is followed by a step B) which is a step of sealing the anodic layer formed on said part during step A).

According to one embodiment of the invention, the method comprises an anodizing step A), a sealing step B) and a marking step D).

In a variant of the invention, the sealing in step B) is carried out in an aqueous solution
deionized water having a resistivity equal to or greater than 0.01 MOhms, preferably equal to or greater than 0.1 Mohms, and more preferably equal to or greater than 10 Mohms), and
1 to 500 g/L of an alkali metal or alkaline earth metal silicate.

The alkali metal or alkaline earth metal silicate can be selected from the group consisting of lithium silicate, sodium silicate, potassium silicate, calcium silicate and magnesium silicate.

The water quality of the sealing bath is important because it has an impact on the resistance of the anodic layer formed on the face part to bio-corrosion. Purer water, such as water with a resistivity of 10 MOhms or more, is likely to provide better performance over time than water with a resistivity of less than 10 MOhms. According to a preferred variant, the deionized water is assembly water, i.e. water used to fill an active bath during assembly/filling thereof, said water having a resistivity equal to or greater than 0.01 MOhms, preferably equal to or greater than 0.1 MOhms, more preferably equal to or greater than 10 MOhms.

In the sealing step B), the concentration of alkali metal or alkaline earth metal silicate in the solution is preferably between 15 and 40 g/L, for example equal to 23 g/L.

In another variant, the sealing in step B) is carried out in deionized water with a resistivity equal to or greater than 0.01 MOhms, preferably equal to or greater than 0.1 Mohms, and more preferably equal to or greater than 10 Mohms).

In all the variants and embodiments of the invention, the temperature of the sealing solution in step B) can be between 60° C. and 100° C., preferably between 97° C. and 100° C., for example 98° C.

In all the variants and embodiments of the invention, the duration of the sealing step B) is between 1 and 40 minutes, preferably between 15 and 40 minutes, for example 30 minutes. This is applicable when sealing is carried out only with water without Silicate salt as described just above

When sealing with silicate salt, the duration is 15 to 25 minutes, preferably 20 minutes.

In accordance with one embodiment of the invention, after step A) and prior to the silicate salt sealing step (step B), an immersion step A1) is carried out on said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1));

then optionally
in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2); can take place.

The trivalent chromium salt can be, for example, one of the following commercial products: Surtec 650 from the company SURTEC, Lanthane 613.3 from the company COVENTYA, TCS from the company SOCOMORE, Bonderite MNT 65000 from the company HENKEL.

The oxidizing compound can be, for example, the product PACS of the company SOCOMORE.

In the immersion step A1), the steps A1-1) and A1-2) can take place successively in the following order: step A1-1) then step A1-2). The immersion step A1) can also be step A1-1) alone without being followed by step A1-2).

The temperature of the aqueous bath containing the trivalent chromium salt and that of the aqueous bath containing the oxidising compound in steps A1-1) and A1-2) as described above are between 2° and 80° C., preferably between 2° and 60° C. The temperatures of the two baths can be the same or different.

The immersion time in each bath in step A1) may be the same or different. It can be between 5 and 40 minutes, preferably between 5 and 20 minutes.

The pH of the bath containing a trivalent chromium salt can be between 3 and 4.5, preferably between 3 and 4, for example 3.5.

The concentration of trivalent chromium salt in the bath is preferably between 0.5 and 500 g/L.

The pH of the bath containing an oxidizing compound is between 3 and 6.

The concentration of oxidizing compound in the bath is preferably between 0.1 and 500 g/L.

According to another embodiment of the invention, the process also comprises a final hydrothermal sealing before step D) and after the sealing according to step B), which will be referred to as step C). The final hydrothermal sealing C) is carried out in deionized water with a resistivity equal to or greater than 0.01 MOhms, preferably equal to or greater than 0.1 MOhms, and more preferably equal to or greater than 10 MOhms, and at a temperature greater than 96° C., for example between 97 and 100° C.

In the final hydrothermal sealing C), the part is immersed in deionized water with a resistivity advantageously equal to or greater than 10 MOhms. The immersion of the part in this step can be from 10 to 30 minutes, preferably from 15 to 25 minutes.

The marking step D) is carried out by a fiber laser beam which has one or more of the following characteristics
a wavelength greater than 800 nm, for example equal to 1064 nm,
a pulse duration of between 0.5 and 10 ns,
a laser frequency of between 400 and 3000 kHz,
a power of between 5 and 80 W, for example between 8 and 20 W,
a speed of between 1000 and 3000 mm/s,
a line spacing of between 0.0001 and 0.1 mm,
a marking time of between 4 and 200 sec.

The inventors have found that the corrosion behavior of the aluminum and aluminum alloy part after the fiber laser treatment in step D) shows that
(1) a clever and appropriate choice of parameters can be used to create surface contrast marks with different geometries and topographies;
(2) ultrafast and efficient laser treatment according to step D) creates contrasting surface markings without affecting and/or changing the microstructure of the aluminum or aluminum alloy part.

In fact, the laser treatment of step D) enables to produce dark or even black marks, thus contrasting on aluminum or aluminum alloy parts, which are therefore high-contrast and easy to read in all light conditions.

The marking in step D) involves marking an anodized surface with a fiber-reinforced ray of laser to produce a dark, high-contrast inscription in the layer without piercing the anodic layer. This marking can be seen as a laser machining method that creates an extremely dark, high-contrast marking on a surface, without removing any material. Extremely short laser pulses create nano-scale structures on the surface. This microstructured surface reduces light scattering, and the resulting mark has a deep, stable blackening.

Thanks to a clever choice of parameters, the step D) avoids impacting the part and keeps the marks within the thickness of the oxide layer. Unlike currently known and used marking methods, the part marked under the conditions of step D) does not require post-marking treatment (by chemical conversion, for example) to be protected against corrosion and biocorrosion, since the marking is contained in the anodic layer without having reached the (underlying) aluminum substrate. The marked part's resistance to biocorrosion and corrosion, in particular when exposed to salt and salt spray, is thus improved compared to another engraving/marking technique.

The marking step D) can be carried out using any type of fiber laser that has the above-mentioned characteristics.

In the case of a fiber laser, the amplifying medium is an optical fiber doped with rare earth elements such as samarium, erbium, ytterbium, neodymium, dysprosium, praseodymium, thulium and holmium. The wavelength obtained depends on the element chosen. Some wavelengths are given as examples for a few elements: samarium 0.6 μm; ytterbium 1.05 μm; erbium 1.55 μm; thulium 1.94 μm; holmium 2.1 μm.

The spot created by the fiber laser beam is small, limiting the amount of energy that is converted into thermal energy. This means that the treated surface is protected from damage caused by heat or fractures.

Another advantage is that fiber lasers are energy-efficient.

In one embodiment of the invention, the fiber laser is a system in which the amplifying medium is an optical fiber doped with ytterbium.

In a preferred embodiment, the marking in step D) is carried out with a fiber laser which is a Master Oscillator Power Amplifier (MOPA) laser. Examples of this type of laser include the TF 420 laser from TECHNIFOR, or the SpeedMarker 700 laser from TROTEC.

As already indicated, the marking in step D) is carried out in the thickness of the aluminum oxide/hydroxide layer without removing any material and without reaching the part itself. Thus, the laser marking in step D) is carried out on a layer of aluminum oxides/hydroxides at least 3 μm thick, for example at least 4 μm thick, for example between 4 and 6 μm thick. Preferably, the laser marking in step D) is carried out on an aluminum oxide/hydroxide layer thickness of approximately 5 μm.

The step D) can be carried out using a fiber laser with a wavelength greater than 800 nm, for example 1064 nm.

The laser pulse duration can be between 0.5 and 10 ns, preferably between 1 and 7 ns, more preferably between 1 and 4 ns.

The laser frequency can be between 400 and 3000 kHz.

The power of the fiber laser is between 5 and 80 W, for example between 8 and 20 W.

The speed of the fiber laser beam can be between 1000 and 3000 mm/s.

The line spacing can be between 0.0001 and 0.1 mm.

The marking time in step D) can be between 4 and 200 sec.

The laser beam is pulsed and releases energy at specific intervals. The speed and line spacing are the two parameters that determine the distance between two pulses.

In one embodiment of the invention, the method for marking the surface of an aluminum or aluminum alloy part comprises the following steps:
A) an anodizing step during which said part is immersed in an aqueous bath containing sulfuric acid at a concentration of between 150 and 250 g/L and at a temperature of between 14 and 21° C., and
a direct voltage is applied to said immersed part according to a voltage profile comprising a voltage rise at a speed of less than 1 V/min until reaching a voltage value referred to as plateau value of between 5 and 13 V; and
B) a step of sealing the anodic layer formed on said part at the end of step A) with the sealing in place
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C.,
or
in the deionized water having a resistivity equal to or greater than 0.01 MOhms, preferably equal to or greater than 0.1 MOhms, more preferably equal to or greater than 10 MOhms, at a temperature of between 60° C. and 100° C.; and
D) a fiber laser marking step having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

In another embodiment of the invention, the method for marking the surface of an aluminum or aluminum alloy parts comprises the following steps:
A) an anodizing step during which said part is immersed in an aqueous bath containing sulfuric acid at a concentration of between 150 and 250 g/L and at a temperature of between 14 and 21° C., and
a direct voltage is applied to said immersed part according to a voltage profile comprising a voltage rise at a speed of less than 1 V/min until a voltage value referred to as plateau value of between 5 and 13 V is reached;
A1) a step of immersing said part,
   in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂),Cr₃ (OH)₂,xH₂O, Cr₂(SO₄)₃,xH₂O, CrK(SO₄)₂,xH₂O (step A1-1));
then (optional)
   in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2)); and
B) a step of sealing the anodic layer formed on said part at the end of step A)
with the sealing in place
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C.,
or
in the deionized water having a resistivity equal to or greater than 0.01 MOhms, preferably equal to or greater than 0.1 MOhms, more preferably equal to or greater than 10 MOhms, at a temperature of between 60° C. and 100° C.; and
D) a fiber laser marking step having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

In another embodiment of the invention, the method for marking the surface of an aluminum or aluminum alloy part comprises the following steps:
A) an anodizing step during which said part is immersed in an aqueous bath containing sulfuric acid at a concentration of between 150 and 250 g/L and at a temperature of between 14 and 21° C., and
a direct voltage is applied to said immersed part according to a voltage profile comprising a voltage rise at a speed of less than 1 V/min until a voltage value referred to as plateau value of between 5 and 13 V is reached;
A1) a step of immersing said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1));
then (optional)
   in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2);
B) a step of sealing the anodic layer formed on said part at the end of step A) with the sealing in place
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C.,
or
in the deionized water having a resistivity equal to or greater than 0.01 MOhms, preferably equal to or greater than 0.1 MOhms, more preferably equal to or greater than 10 MOhms, at a temperature of between 60° C. and 100° C.; and
C) a final hydrothermal sealing in deionized water with a resistivity equal to or greater than 0.01 MOhms, preferably equal to or greater than 0.1 MOhms, and more preferably equal to or greater than 10 MOhms, at a temperature between 97 and 100° C.; and
D) a fiber laser marking step having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

In another embodiment of the invention, the method for marking the surface of an aluminum or aluminum alloy part comprises the following steps:
A) an anodizing step during which said part is immersed in an aqueous bath containing sulfuric acid at a concentration of between 150 and 250 g/L and at a temperature of between 14 and 21° C., and
a direct voltage is applied to said immersed part according to a voltage profile comprising a voltage rise at a speed of less than 1 V/min until a voltage value referred to as plateau value of between 5 and 13 V is reached;
A1) a step of immersing said part,
   in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1)); and
B) a step of sealing the anodic layer formed on said part at the end of step A) with the sealing in place
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C.,
or
in the deionized water having a resistivity equal to or greater than 0.01 MOhms, preferably equal to or greater than 0.1 MOhms, more preferably equal to or greater than 10 MOhms, at a temperature of between 60° C. and 100° C.; and
D) a fiber laser marking step having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

In another embodiment of the invention, the method for marking the surface of an aluminum or aluminum alloy part comprises the following steps:
A) an anodizing step during which said part is immersed in an aqueous bath containing sulfuric acid at a concentration of between 150 and 250 g/L and at a temperature of between 14 and 21° C., and
a direct voltage is applied to said immersed part according to a voltage profile comprising a voltage rise at a speed of less than 1 V/min until a voltage value referred to as plateau value of between 5 and 13 V is reached;
Im) a step of impregnating the said anodized part at the end of step A) in a bath of organic or inorganic dyes, then optionally
A1) a step of immersing said part,
   in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂),Cr₃ (OH)₂,xH₂O, Cr₂(SO₄)₃,xH₂O, CrK(SO₄)₂,xH₂O (step A1-1));
then (optional)
   in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2)); and then optionally
B) a step of sealing the anodic layer formed on said part at the end of step A) with the sealing in place
in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline earth metal silicate, at a temperature of between 60° C. and 100° C.,
or
in the deionized water having a resistivity equal to or greater than 0.01 MOhms, preferably equal to or greater than 0.1 MOhms, more preferably equal to or greater than 10 MOhms, at a temperature of between 60° C. and 100° C.; and
D) a fiber laser marking step having one or more of the following characteristics
   a wavelength greater than 800 nm, for example equal to 1064 nm,
   a pulse duration of between 0.5 and 10 ns,
   a laser frequency of between 400 and 3000 kHz,
   a power of between 5 and 80 W, for example between 8 and 20 W,
   a speed of between 1000 and 3000 mm/s,
   a line spacing of between 0.0001 and 0.1 mm,
   a marking time of between 4 and 200 sec.

The step Im), which follows step A), can be carried out using any technique known to the person skilled in the art. For example, it can be realized in a dye bath adapted to the surface treatment available from companies like Clariant. As an example, we can mention the organic dye Sanodal Blue (from the company Clariant) with a concentration of 3 g/L to which 2 g/L of sodium acetate must be added, pH between 5 and 6 at a temperature between 4° and 65° C., preferably equal to 50° C., for a duration of between 5 and 35 minutes, preferably equal to 20 minutes. The active principle of the organic dye is the Anthraquinone molecule.

In all embodiments, before subjecting the part to the surface treatment method of the invention and therefore prior to the anodizing step A), the part may be subjected to a surface preparation step by degreasing and/or pickling in order to remove the grease, dirt and oxides present on its surface.

This preliminary step of surface preparation can comprise one or more of the following operations:
solvent degreasing, to dissolve grease on the surface of the part. This operation can be realized by soaking, spraying, or any other method known to the person skilled in the art;
alkaline degreasing, to dissolve grease on the surface of the part. This operation can be realized by soaking, spraying, or any other technique known to the person skilled in the art;
alkaline pickling, to dissolve the oxides naturally formed on the surface of the part. This operation can be realized by soaking, spraying, or any other technique known to the person skilled in the art. At the end of this operation, the part is covered with a powdery layer formed by oxidation products of intermetallic compounds, which must be removed by an acid pickling step;
acid pickling, to dissolve the oxides naturally formed on the surface of the part, and/or the oxidation layer formed on the surface of the part during the alkaline pickling step. This operation can be realized by soaking, spraying, or any other technique known to the person skilled in the art.

These steps are described in detail, for example, in the application WO 2013/117759.

Intermediate rinses, in particular with demineralized water, are preferably realized between the above successive steps and before the part is treated by anodization.

The method of the invention is of great interest in any type of industry where contrasting marking of aluminum or aluminum alloy part with good resistance of the parts to corrosion, biocorrosion, salt spray and salt exposure is required.

Once the marking has been made (without physico-chemical post-treatment) on an aluminum or aluminum alloy part, such as the alloy 2024T3 for example, using the method of the invention,
if the part is subjected to a salt spray test (168 hours of exposure in accordance with ISO9227), no corrosion is observed at the end of the test, while guaranteeing the legibility and visibility of the marking, and
if the part is subjected to a 15-day immersion biocorrosion test in accordance with § 4.7.19 of the standard MIL-C-27725B, the marking is not corroded at the end of the test while guaranteeing legibility and visibility of the marking. It should be noted that biocorrosion resistance is only guaranteed when the ranges and associated variants contain at least the step of sealing with a Silicate salt as described above

It should be noted that a contrasted or non-contrasted laser marking that had reached the part (piercing of the oxide layer) in aluminum or aluminum alloy, such as the alloy 2024T3, without physico-chemical post-treatment, would show signs of corrosion before the requirement of 168 hours of saline exposure according to ISO9227.

One of the advantages of marking using the method described in this invention is its visual stability, whatever the angle of observation. The very strong, uniform contrast from all angles is due to the periodic nanostructures, which reflect and absorb light, scattering it as widely as possible. This characteristic represents in particular a guarantee of quality in the clock industry or the automobile industry, which implement many apparent parts.

The dark, high-contrast marking produced by the method considerably improves the visibility and legibility of the marking details, both manually and automatically.

In addition, the marking method of the invention is suitable for small and fine markings, or for DMC (Data Matrix Code) and UDI (Unique Device Identification) codes on small surfaces.

For example, European regulations on medical devices and FDA (Food and Drug Administration) regulations in the United States require medical technology products to carry a UDI (Unique Device Identification) code that guarantees their traceability and remains legible over time. The marking by the method of the invention predisposes it admirably to the requirements of the UDI-compatible marking. The UDI codes, especially very small ones, remain legible for a long time thanks to their resistance to corrosion, their stability at all viewing angles and their contrasting or even deep black colour.

Another object of the invention concerns the use of a marking method according to the invention for the manufacture or marking of aluminum or aluminum alloy parts intended for the aeronautical, aerospace, automotive, railway, watchmaking, medical, nuclear and oil industries, etc.

### EXAMPLES

### Example 1

### Method for Surface Marking of Aluminum Alloy Parts

Aluminum alloy parts 2024 T3 and AS7G06T6 laminated machined on one of the two sides of dimensions 120×60×2 mm are processed according to the methods described below.

The surface preparation steps of the part are first realized successively:
alkaline degreasing, by soaking the part in a bath of ALUMAL CLEAN 101 (from the company COVENTYA) at a temperature of 60° C., for 20 minutes;
rinsing with tap water or demineralized water;
acid pickling: by soaking the part in a solution of ALUMAL DEOX 411 (from the company COVENTYA);
rinsing with tap water or demineralized water.

The pickled and rinsed parts are then subjected to an anodization method in accordance with the invention, during which the parts are immersed in an aqueous bath comprising sulfuric acid at a concentration of between 160 g/L and 220 g/L, for example equal to 190 g/L. This bath is carried and maintained at a temperature of 18° C. A direct voltage is applied to said immersed parts according to the following voltage profile: a voltage rise from a value of 0V, at a speed of 0.7 V/min until a voltage value referred to as plateau value of 10 V is reached. The voltage is maintained at the plateau value for 40 minutes. An anodic layer 3 to 6 μm thick forms on the surface of the parts.

As a comparative example, identical parts that have undergone the same surface preparation operations are anodized using the conventional methods of chromic acid anodizing (OAC) and fine sulfuric acid anodizing (fine OAS). The operating conditions for these anodizations are shown in [Table 1].

TABLE 1

| | OAC | Fine OAS |
|---|---|---|
| Bath composition | CrO₃ (60 g/L) | H₂SO₄ |
| | C₂H₂O₄ (2 g/L) | |
| Bath temperature (° C.) | 35-42 | 16-20 |
| Voltage rise (V/min) | 7 | 0.7 |
| Voltage and plateau value | 35 V | 10 V |
| time | 45 minutes | 40 minutes |
| Thickness of the anodic | 3 to 5 | 3 to 6 |
| layer formed on the part | | |
| (μm) | | |

The thickness of the anodic layer formed on the part is measured by eddy current according to the standard ISO2360.

The anodized parts are then subjected to one or more rinses, preferably with demineralized water, followed by the sealing operations in accordance with the invention under the conditions and in the order indicated below:
step A1.1) and step A1.2): a step of immersing said parts, successively, in an aqueous bath containing 29% Vol/Vol of trivalent Chromium salt (Chromium III potassium sulphate of chemical formula KCr(SO₄)₂, at a temperature of 40° C. for 20 minutes and at a pH of 3.9, then in an aqueous bath containing 7% Vol/Vol H₂O₂, at a temperature of 25° C. for 5 minutes and at a pH of 4.2;
step B): a sealing by immersion of the parts at the end of the two preceding operations in a mounting aqueous solution of deionized water having a resistivity of 10 MOhms with 23 g/L of a sodium silicate, a temperature of 98° C. and during 20 minutes.

Between each sealing step a rinse with demineralized water is performed for 1 minute at a temperature of about 20° C.

The non-drilling marking step D) (without affecting the part) using a MOPA fiber laser beam was carried out using a SpeedMarker 700 laser from TROTEC under the conditions specified in [Table 2]:

TABLE 2

| Sample | | | | | | | | | | | Resistance |
|---|---|---|---|---|---|---|---|---|---|---|---|
| and | | | | Speed | Laser | Pulse | Line | Marking | | | to salt |
| of type | Marking | Request | % of | in | frequency | duration | spacing | time | Conversion | Electrical | spray |
| treatment | colour | on plan | power | mm/s | in kHz | in ns | in mm | in sec | (Alodine) | conductivity | after 168 h |
| 2024 T3 | White | Undrilled | 40 | 2000 | 400 | 2.5 | 0.01 | 14 | No | Substrate | OK |
| BF5 | | layer | | | | | | | alodine | not | |
| OAC | | | | | | | | | | reached | |
| Chromic | | | | | | | | | | | |
| acid | | | | | | | | | | | |
| anodizing | | | | | | | | | | | |
| AS7G06T6 | Black | Undrilled | 60 | 2000 | 500 | 1.5 | 0.001 | 135 | No | Substrate | OK |
| Fine OAS | | layer | | | | | | | alodine | not | |
| standard | | | | | | | | | | reached | |
| (without | | | | | | | | | | | |
| silicate | | | | | | | | | | | |
| salt) | | | | | | | | | | | |
| 2024 T3 | Black | Undrilled | 60 | 2000 | 500 | 1.5 | 0.001 | 135 | No | Substrate | OK |
| Fine OAS | | layer | | | | | | | alodine | not | |
| with | | | | | | | | | | reached | |
| silicate | | | | | | | | | | | |
| salt | | | | | | | | | | | |
| sealing | | | | | | | | | | | |

The alodine conversion refers to a chemical conversion of the Alodine 1200 type, which is an exclusively chemical method for the long-term protection of aluminum or aluminum alloy surfaces against oxidation. The treatment of Alodine 1200 has been developed to protect surfaces that do not require a paint finish or require only a local finish (salt spray resistance >168 hours).

It ensures maximum adhesion and excellent durability of the finishes applied, thanks to the perfect chemical stability of the surfaces treated.

The Alodine 1200, used in the hardening process, forms a protective coating on aluminum or alloys with virtually no excess thickness. The colour of this coating, depending on the type of alloy or the degree of purity of the metal, varies from yellow to brown.

The Alodine 1200 is approved to the standard MIL C 5541.

### Biocorrosion Resistance

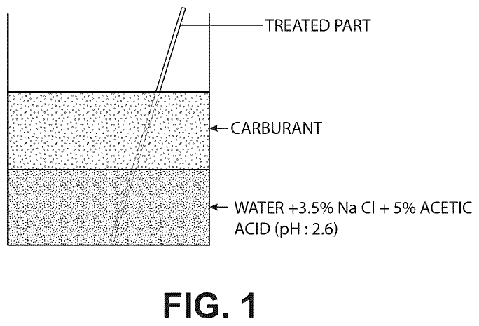

At the end of these operations, a sealed and marked anodic layer is obtained on each treated part. Once treated, the parts are subjected to the immersion test in a medium representative of the bio-corrosion which follows the protocol in § 4.7.19 of the standard MIL-27725B. The diagram of the assembly for carrying out the biocorrosion test in accordance with § 4.7.19 of the standard MIL-C-27725B, with the various parts, is shown in FIG. 1.

The results are assessed visually by removing the parts from the medium to check the visibility and legibility of the marking and any signs of damage caused by the treatment and/or attacks on the substrate by the medium (lower phase). The visual degradation can be confirmed by a measurement of Ohmic resistivity of layer which, when it is not infinite, highlights a deterioration of the layer which can go until the substrate.

Before testing, the Ohmic resistivity method is useful to anticipate the fact that if the electric current passes through two points of the engraving, then the biocorrosion resistance will not be satisfied. On the other hand, there is no requirement after biocorrosion tests if there is no attack on the marking.

This method is carried out systematically after a biocorrosion test on any indications of potential corrosion, and only at the end of the 15-day biocorrosion test.

Method for measuring a resistance with an Ohmmeter:

A multimeter can be used to measure resistance. It must then be used in Ohmmeter mode.

Using the multimeter in Ohmmeter mode:

Choice of terminals: the COM terminal and the terminal carrying the Q symbol.

Connection: the multimeter is connected directly to two points on the test specimen at the end of the test, in the area that was in contact with the lower phase of the two-phase medium.

The size: the highest size is chosen and then it is decreased until the smallest of the sizes above the measured value is found.

[Table 3] summarizes the results of bio-corrosion resistance tests of different surface treatments as a function of the number of days of immersion in the biphasic medium.

TABLE 3

| | | | | | | | | | | | Electrical | Resistance |
|---|---|---|---|---|---|---|---|---|---|---|---|---|
| Sample | | | | | | | | | | | conductivity | to |
| and | | | | Speed | laser | Pulse | Line | Dry | Easy | | before | bio-corrosion |
| type of | Marking | Request | % of | in | frequency | duration | spacing | engraving | to | Conversion | biocorrosion | after 15 |
| treatment | colour | on plan | power | mm/s | in kHz | in ns | in mm | time | read | (Alodine) | test | days' testing |
| Wafer | White | undrilled | 40 | 2000 | 400 | 2.5 | 0.05 | 5 | NOK | No | Substrate | NOK |
| 2024T3 | | layer | | | | | | | | alodine | not | |
| BF5 | | | | | | | | | | | reached | |
| OAC | | | | | | | | | | | | |
| Wafer | White | undrilled | 40 | 2000 | 400 | 2.5 | 0.01 | 18 | NOK | No | Substrate | NOK |
| 2024T3 | | layer | | | | | | | | alodine | not | |
| BF5 | | | | | | | | | | | reached | |
| OAC | | | | | | | | | | | | |
| Wafer | White | undrilled | 40 | 2000 | 400 | 2.5 | 0.005 | 35 | NOK | No | Substrate | NOK |
| 2024T3 | | layer | | | | | | | | alodine | not | |
| BF5 | | | | | | | | | | | reached | |
| OAC | | | | | | | | | | | | |
| Wafer | Black | undrilled | 60 | 2000 | 500 | 1.5 | 0.001 | 174 | OK | No | Substrate | OK |
| 2024T3 | | layer | | | | | | | | alodine | not | |
| Fine | | | | | | | | | | | reached | |
| OAS | | | | | | | | | | | | |
| with | | | | | | | | | | | | |
| silicate | | | | | | | | | | | | |
| salt | | | | | | | | | | | | |
| sealing | | | | | | | | | | | | |
| Wafer | Black | undrilled | 60 | 2000 | 500 | 1.5 | 0.002 | 87 | OK | No | Substrate | OK |
| 2024T3 | | layer | | | | | | | | alodine | not | |
| Fine | | | | | | | | | | | reached | |
| OAS | | | | | | | | | | | | |
| with | | | | | | | | | | | | |
| silicate | | | | | | | | | | | | |
| salt | | | | | | | | | | | | |
| sealing | | | | | | | | | | | | |
| Wafer | Black | undrilled | 60 | 2000 | 500 | 1.5 | 0.003 | 59 | OK | No | Substrate | OK |
| 2024T3 | | layer | | | | | | | | alodine | not | |
| Fine | | | | | | | | | | | reached | |
| OAS | | | | | | | | | | | | |
| with | | | | | | | | | | | | |
| silicate | | | | | | | | | | | | |
| salt | | | | | | | | | | | | |
| sealing | | | | | | | | | | | | |

“NOK” means not in compliance with the criteria for either reading or expected resistance to biocorrosion.

The corrosion by pits is a localized corrosion that results in the formation of irregularly shaped cavities on the surface of the aluminum alloy part. They occur when the aluminum alloy part is brought into contact with an aqueous solution containing halide ions, most frequently chloride ions. Based on the results shown in [Table 3], it is clear that the 168 hour resistance according to the ISO9227 is good for all three samples. There is no corrosion at the end of the test, and the markings remain legible.

Various black marking tests were carried out on different substrates (2024T3 and AS7G06T6), some of which remained in the layer and did not reach the substrate, while others did reach the substrate. This last case could be detected by measuring the current flow at two points on the marking (if the current flowed, the layer had been completely pierced).

1) Fine OAS Test Tube by Sulfuric Acid Anodizing (as Described Above and/or According to Patent Application n° FR3106837), after Marking and Before Exposure to Salt Spray According to ISO9227

For a 2024 T3 alloy specimen (fine OAS with silicate salt sealing) and for an AS7G06T6 alloy specimen (standard fine OAS-without silicate salt), the markings are intact and legible.

2) Fine OAS Test Tube by Sulfuric Acid Anodizing (as Described Above and/or in Accordance with Patent Application n° FR3106837), after Marking and after 168 Hours of Exposure to Salt Spray in Accordance with ISO9227

For a 2024 T3 alloy specimen (fine OAS with silicate salt sealing), no corrosion was detected on the markings (electrically insulating markings before testing) after exposure to salt spray. The markings are intact and still legible.

For an AS7G06T6 alloy specimen (fine OAS standard-without silicate salt), no corrosion was detected on the markings (electrically insulating markings before testing) after exposure to salt spray. The markings are intact and still legible. However, significant corrosion was detected on the other markings (all of which were electrically conductive before the test, indicating that the laser marking had pierced the anodic layer and reached the substrate).

3) Fine OAS Test Tube by Sulfuric Acid Anodizing (as Described Above and/or in Accordance with Patent Application n° FR3106837), after 15-Day Immersion Biocorrosion Test in Accordance with § 4.7.19 of Standard MIL-C-27725B

For a 2024 T3 alloy specimen (fine OAS with silicate salt sealing), and for an AS7G06T6 alloy specimen (standard fine OAS-without silicate salt), no corrosion was detected on the markings after 15 days of immersion in accordance with § 4.7.19 of the standard MIL-C-27725B. The markings are intact and remain contrasted and legible.

These tests clearly show that the desired objectives, namely,
create a contrasting marking to facilitate visibility and legibility and the reading of the marking,
remove the requirement for post-marking chemical conversion, for example with Bonderite MCR 1200),
obtain high-contrast laser marking that is resistant to neutral salt spray in accordance with ISO9227 for a minimum of 168 hours,
obtain a contrasting laser marking that resists biocorrosion after 15 days of immersion in accordance with § 4.7.19 of standard MIL-C-27725B, have been reached by parts treated using the method described above.

The aeronautical requirements for resistance to salt spray (168 h of exposure according to ISO 9227) and resistance to biocorrosion after 15 days of immersion according to § 4.7.19 of standard MIL-C-27725B, are also met by the marking process of the invention.

In conclusion, the method for marking aluminum or aluminum alloy parts according to the invention makes it easy to read the marks with a digital code reader. The marking of these parts ensures that they withstand salt corrosion without the need for post chemical conversion, and that they withstand biocorrosion.

The marking method according to the invention is therefore of great interest in all sectors using datamatrix or marking requiring a minimum of contrast to facilitate reading and resistance to (bio) corrosion, such as, for example, aeronautical and space equipment in general, the nuclear industry, the offshore (oil) industry, the automotive industry, the rail industry, etc.

1. A method for marking the surface of an aluminum or aluminum alloy part, the method comprising the steps of:
A) anodizing the part;
B) sealing an anodic layer formed on said part at the end of step A), with the sealing being carried out:
(1) in an aqueous solution of deionized water having a resistivity equal to or greater than 0.01 MOhms, and from 1 to 500 g/L of an alkali metal or alkaline earth metal silicate, at a temperature of between 60° C. and 100° C., or
(2) in the deionized water with a resistivity equal to or greater than 0.01 MOhms, at a temperature of between 60° C. and 100° C.; and
D) marking the part using a fiber laser beam having one or more of the following characteristics;
a wavelength greater than 800 nm,
a pulse duration of between 0.5 and 10 ns,
a laser frequency of between 400 and 3000 kHz,
a power between 5 and 80 W,
a speed of between 1000 and 3000 mm/s,
a line spacing of between 0.0001 and 0.1 mm,
a marking time of between 4 and 200 sec.

2. The method according to claim 1, wherein the anodizing step A) is an anodization of the TSA (tartric sulfuric anodizing), OAS (sulfuric acid anodizing), fine OAS (fine sulfuric acid anodizing), PSAA (phosphoric sulfuric acid anodizing), BSAA (boric sulfuric acid anodizing), or OAC (chromic acid anodizing) type.

3. The method according to claim 1, wherein during the anodizing step A) said part is immersed in an aqueous bath comprising sulfuric acid at a concentration of between 150 and 250 g/L and at a temperature of between 14 and 21° C., and
a direct voltage is applied to said immersed part according to a voltage profile comprising a voltage rise at a speed of less than 1 V/min until a voltage value referred to as plateau value of between 5 and 13 V is reached.

4. The method according to claim 1, wherein the aluminum alloy is selected from the group consisting of 2014, 2017A, 2024, 2214, 2219, 2618, AU5NKZr, 7175, 5052, 5086, 6061, 6063, 7010, 7020, 7050, 7050 T7451, 7055 T77, 7068, 7085 T7651, 7075, 7175 and 7475, AS7G06, AS7G03, AS10G, AS9U3, AS7G06, AS7G06 and AS10G being obtained by additive manufacturing.

5. The method according to claim 1, wherein the alkali metal or alkaline earth metal silicate is selected from the group consisting of lithium silicate, sodium silicate, potassium silicate, calcium silicate and magnesium silicate.

6. The method according to claim 1, wherein the marking step D) is carried out with a fiber laser which is a system in which the amplifying medium is an optical fiber doped with ytterbium.

7. The method according to claim 1, wherein the marking step D) is carried out with a fiber laser which is a master oscillator power amplifier laser or MOPA.

8. The method according to claim 1 further comprising, after step A) and prior to the silicate salt sealing step (step B)), a step A1) of immersing said part,
in an aqueous bath containing a trivalent chromium salt selected from the group consisting of CrF3,xH2O, CrC13,xH2O, Cr(NO3)3,xH2O, (CH3CO₂)2Cr,xH2O, (CH3CO₂)7Cr3(OH)2,xH2O, Cr2(SO4)3,xH2O, CrK(SO4)2,xH2O (step A1-1)).

9. The method according to claim 1, further comprising, before step D) and after the sealing according to step B), a step C) of final hydrothermal sealing in deionized water with a resistivity equal to or greater than 0.01 MOhms, at a temperature greater than 96° C.

10. The method according to claim 2, wherein during the anodizing step A) said part is immersed in an aqueous bath comprising sulfuric acid at a concentration of between 150 and 250 g/L and at a temperature of between 14 and 21° C., and
a direct voltage is applied to said immersed part according to a voltage profile comprising a voltage rise at a speed of less than 1 V/min until a voltage value referred to as plateau value of between 5 and 13 V is reached.

11. The method according to claim 3, further comprising after step A) and prior to the silicate salt sealing step (step B)), a step A1) of:
A1-1) immersing said part in an aqueous bath containing a trivalent chromium salt selected from the group consisting of CrF3,xH2O, CrCl3,xH2O, Cr(NO3)3,xH2O, (CH3CO₂)2Cr,xH2O, (CH3CO₂)7Cr3(OH)2,xH2O, Cr2(SO4)3,xH2O, CrK(SO4)2,xH2O, and then
A1-2) immersing said part in an aqueous bath containing an oxidizing compound selected from the group consisting of hydrogen peroxide (H2O2), ammonium fluoride (NH4F), potassium fluoro-zirconate (K2ZrF6), potassium permanganate (KMnO4), sodium permanganate (NaMnO4).

12. The method according to claim 11, further comprising before step D) and after the sealing according to step B), a step C) of final hydrothermal sealing in deionized water with a resistivity equal to or greater than 0.01 MOhms, at a temperature greater than 96° C.

13. The method according to claim 3, further comprising after step A) and prior to the silicate salt sealing step (step B)), a step A1) of:
A1-1) immersing said part in an aqueous bath containing a trivalent chromium salt selected from the group consisting of CrF3,xH2O, CrCl3,xH2O, Cr(NO3)3,xH2O, (CH3CO₂)2Cr,xH2O, (CH3CO₂)7Cr3(OH)2,xH2O, Cr2(SO4)3,xH2O, CrK(SO4)2,xH2O.

14. The method according to claim 3, further comprising the step of:
Im) a step of impregnating the said anodized part at the end of step A) in a bath of organic or inorganic dyes.

15. A method for the manufacture or marking of aluminum or aluminum alloy parts intended for the aeronautical, aerospace, automotive, rail, watchmaking, medical, nuclear and oil sectors, the method including the marking method of claim 1.

16. The method according to claim 8, wherein step A1) further comprises immersing said part in an aqueous bath containing an oxidizing compound selected from the group consisting of hydrogen peroxide (H2O2), ammonium fluoride (NH4F), potassium fluoro-zirconate (K2ZrF6), potassium permanganate (KMnO4), sodium permanganate (NaMnO4) (step A1-2)).

17. The method according to claim 14, further comprising, after step A) and prior to the silicate salt sealing step (step B)), the steps of:
A1-1) immersing said part in an aqueous bath containing a trivalent chromium salt selected from the group consisting of CrF3,xH2O, CrC13,xH2O, Cr(NO3)3,xH2O, (CH3CO₂)2Cr,xH2O, (CH3CO₂)7Cr3(OH)2,xH2O, Cr2(SO4)3,xH2O, CrK(SO4)2,xH2O; and then
A1-2) immersing said part in an aqueous bath containing an oxidizing compound selected from the group consisting of hydrogen peroxide (H2O2), ammonium fluoride (NH4F), potassium fluoro-zirconate (K2ZrF6), potassium permanganate (KMnO4), sodium permanganate (NaMnO4).
